(19) United States
(12) Patent Application Publication
(10) Pub. No.: US 2004/0015338 A1
(43) Pub. Date: Jan. 22, 2004

(54) Method and apparatus for automated signal integrity checking

(76) Inventors: William Richard Lawrence, Windsor, CO (US); Francisco A. Ostojic, Fort Collins, CO (US); Michael Rogers Lambert, Fort Collins, CO (US); Robert J. Martin, Timnath, CO (US); Edward V. Weber, Ft. Collins, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/199,635

(22) Filed: Jul. 19, 2002

(51) Int. Cl. G06G 7/62

(52) U.S. Cl. 703/13; 324/500

(57) ABSTRACT

The present invention is directed to a method and apparatus for simulating digital electronic systems. The signal integrity of a digital electronic system is assessed by analyzing traces (e.g. wires between components) for cross coupling. Problem areas are identified by monitoring storage components or output ports of the electronic system. Wires (traces), which carry signal transitions to the storage component or output ports are analyzed and quantified based on timing windows associated with the wires (traces). The clock transitions into a storage device are analyzed and vulnerability windows are identified for the storage device. The vulnerability windows are time periods when cross coupling may occur on a storage device. If a timing window overlaps a vulnerability window the timing window is considered a critical timing window. Devices driving the transition on wires with critical timing windows are then analyzed. Adjustments are made to the parameters of the driving devices to create a worse case scenario. The worse case scenario is simulated and analyzed for cross-coupling.

### CROSS-REFERENCE TO RELATED APPLICATION

This application is related to U.S. application Ser. No. ______ filed ______, which is hereby incorporated by reference in its entirety.

### BACKGROUND OF THE INVENTION

1. Field of the Invention

This invention relates to simulation. Specifically, the present invention relates to the simulation of electronic systems.

2. Description of the Related Art

Modern electronic systems have advanced over the last several decades. Electronic systems are now implemented in integrated circuits and on printed circuit boards. Integrated circuits and printed circuit boards that once included thousands of transistors and logic gates now include millions of transistors and logic gates.

As electronic systems have become more sophisticated and complex, peripheral and support technologies have also had to become more sophisticated and complex to implement and use the electronic systems. One area that has seen tremendous advancement is the area of testing and simulation of electronic systems. As these systems have increased in complexity and speed, customer requirements have dictated that the design cycles required to implement these systems be reduced. As a result, there is a greater focus on the areas of testing and simulation.

When electronic systems included thousands of circuits it was possible for simulation tools to model every component. As electronic systems have become more complex and include more components, simulation tools have also had to become more complex. In addition, new techniques for simulating these systems have developed.

One area that has received some amount of attention is the area of signal integrity. With so many components (e.g. transistors, logic gates, storage units) located so close together, signals often couple to other signals (e.g. cross-couple). Therefore in addition to the analysis of electronic systems and the electronic components in these systems, analysis is now being performed on the signals running between components (e.g. traces) or the signal integrity of the system.

Conventional simulation tools may be used to analyze the signal integrity of these electronic systems. However with millions of components located within these electronic systems, the simulation of components and traces between components is a substantial computational task. Running a simulation on an integrated circuit with millions of electronic components can exhaust the resources of a supercomputer for hours, months or even years depending on the sophistication of the simulation.

One specific type of signal integrity check addresses the problem of cross-coupling between traces. With so many devices located so close together in a small area, the wires (traces wires) conducting electricity (e.g. trace currents) to these components are also placed close together. The electricity running in one wire may couple onto a second wire. The wire, which couples onto the second wire, is often referred to as an aggressor wire. The wire that is coupled onto by the aggressor wire is often referred to as a victim wire. The coupling is a capacitive coupling and is often simulated using a circuit that includes a capacitor between the two wires (traces). However with millions of electronic components fed by hundreds of millions of wires (traces), simulating cross-coupling is a substantial computational task.

Design techniques have been implemented to address the cross-coupling problem. In one technique, the wires (traces) that have the cross-coupling problem, are separated so that their capacitive effects do not interfere with each other. In a second technique, a ground wire may be placed between a victim wire and aggressor wire and as a result, any leaks in the electricity running on the wires (traces) will go to ground, rather than going from the aggressor to the victim. However, implementing these design techniques requires that we first identify each cross-coupling problem and then redesign the integrated circuit or printed circuit board to address the cross-coupling problem. The identification and redesign of these problems are typically performed using conventional simulation tools such as software simulators. However once again, the sheer volume of the analysis can be a daunting computational task.

Thus there is a need in the art for techniques that simulate signal integrity in electronic systems. There is a need in the art for reducing the complexity and computation required when performing these simulations. Lastly there is a need in the art for a quick and accurate simulation of the cross-coupling problem.

### SUMMARY OF THE INVENTION

The present invention is directed to a method and apparatus for simulating electronic systems. In the present invention, traces carry transitions and have timing windows. In addition, storage devices in electronic systems include data inputs and clock inputs. The data inputs to the storage device carry transition signals to the storage device. In addition, the clock inputs to the storage device carry timing transitions to the storage device. The data input to the storage devices have timing windows and the clock inputs to the storage device include timing windows. In addition, a vulnerability window is defined for the storage device. The vulnerability window is a time period when the storage device may produce invalid data if an input to the storage device receives noise (e.g. cross-coupling) during that time period. The victim vulnerability window is associated with the clock input to the storage device. Critical timing windows are then defined as timing windows that occur on data inputs and overlap with the victim vulnerability window. Once the critical timing windows are identified the devices driving the transition on aggressor wires associated with the critical timing windows, are adjusted to create a worse case scenario for simulation. An extracted model of the circuit under study is then developed for the purposes of simulation. Storage elements in the extracted circuit are analyzed. Invalid data on a storage element denotes a cross-coupling problem exists.

A method of determining signal integrity is presented. The method of determining signal integrity comprises the steps of, defining a victim vulnerability window. Identifying a plurality of critical timing windows in response to defining the victim vulnerability window; and determining signal integrity in response to the plurality of critical timing windows.

A second method of performing simulation is presented. The second method of performing simulation comprises the steps of determining timing windows in a circuit including traces, each trace connecting driving devices to storage devices. Defining a victim vulnerability window. Determining critical timing windows in response to the timing windows and in response to the victim vulnerability window. Determining aggressor traces in response to the critical timing windows. Determining victim traces receiving enough coupling from the aggressor traces. Identifying a subset of the storage devices in response to the victim traces. Generating an extracted circuit in response to the aggressor traces, in response to the victim traces and in response to the subset of storage devices. Generating a worse case scenario in response to the extracted circuit; and simulating the worse case scenario.

A method for determining a vulnerability window for a storage device including an input is presented. The method comprises the steps of defining a clock transition; defining a first boundary of the vulnerability window as the clock transition, minus a setup time for the storage device, minus a recovery time for the input to the storage device; and defining a second boundary of the vulnerability window as the clock transition plus the hold time for the storage device.

### BRIEF DESCRIPTION OF THE DRAWINGS

FIG. 1 is an electronic circuit implementing the present invention.

FIG. 2 is a diagram of timing windows.

FIG. 3 is a timing diagram of the circuit shown in FIG. 1.

FIG. 4 is an extracted circuit of the circuit shown in FIG. 1.

FIG. 5 is a diagram of a computer implementing the present invention.

FIG. 6 is a flow diagram of the method of the present invention.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

In digital electronic systems implemented in accordance with the teachings of the present invention, data signals traveling on wires or traces are characterized as in a high state (e.g. logical 1) or in a low state (e.g. logical 0). In addition, the signals communicated on traces may transition from a high state to a low state. The transition is characterized as a rising transition when the signal goes from a low state to a high state. The transition is characterized as a falling transition when the signal goes from a high state to a low state.

A transition moves along a wire or trace and through the electronic system, arriving at different locations at different times. For example, at time T1 a transition may be at one point in a trace between two devices and at time T2, the transition may be at another point in the trace between the two devices. Since transitions arrive at some parts of the electronic system faster than at other parts of the electronic system, storage devices are used to “gate” and resynchronize the data being processed by electronic systems.

In digital electronic systems, clock signals are also characterized as high (e.g. 1) or low (e.g. 0). In addition, clock signals may transition from high to low. A rising transition would be characterized by a clock signal moving from a low state to a high state. A falling transition would be characterized by a clock signal moving from a high state to a low state.

Digital electronic systems are typically controlled by one or more clock signals. At each change or transition of a clock signal(s) the components (e.g. gates, storage devices, etc) of the electronic system can change states. However, it should be appreciated that not every component changes state on every transition of a clock signal.

Storage devices in a digital electronic system may include a data input and a clock input. A logical high (e.g. 1) may be communicated on a data input to a storage device or a logical low (e.g. 0) may be communicated on a data input to a storage device. When a storage device stores a value (e.g. 1 or 0) and is not transitioning, the storage device is said to be in steady state. A storage device is either in steady state or transitioning. The transitions traveling on a data input to a storage device may also be characterized as rising or falling. A rising transition occurs when the input signal to the storage device moves from a low to a high and a falling transition occurs when the data input signal to a storage device moves from a high to a low.

A storage device in a digital electronic system also receives a clock input. The clock input may be high, low or transitioning. A high signal corresponds to a logical one. A low signal corresponds to a logical zero. In addition, the clock signal may have a rising transition in which the clock signal transitions from a low to a high or a falling transition in which the clock signal transitions from a high to a low.

In addition, a storage device may be in steady state and may change states based on signal transitions of the clock signal and the data signal. A storage device changes its internal state when its clock input changes. The new state is a function of the current state and its data input.

In the present invention, a timing window is associated with each wire (or trace) in the electronic system. A timing window is a time period that is bounded by the earliest time that a transition may occur and the latest time a transition may occur. Therefore the timing window gives the outer timing boundary, for signal transitions entering an electronic component.

In addition to the timing windows, storage components such as latches and flip-flops take time to change states. The time required to change states (e.g. transitions) is known as the set-up and hold time and consist of two parts. The first part is known as the set-up time and the second part is known as the hold time. Storage device circuits require the data input become stable some time before the clock transition. The time period that the data must be stable before the clock transition is referred to as the setup time. In addition the data input must remain stable until some time after the clock transition. The time period when the data input must remain stable after the clock transition is referred to as the hold time. Should the data input change between the clock transition minus the setup time and clock transition plus the hold time, the new state of the storage device is indeterminate. An indeterminate state results in incorrect circuit operation. It should also be noted that setup and hold times are a function of the storage device design.

Digital circuit design involves insuring that the data input to a storage device remains stable during the time from the clock minus setup time to the clock plus hold time for every storage device in the design. This is done by designing the delays of the non-storage devices and their interconnecting wires so that signals arrive at the storage devices before the clock transition minus the setup time and remain unchanged until the clock transition plus the hold time. For the purposes of discussion, the time period from the clock transition minus the setup time to the clock transition plus the hold time may be referred to as the set up and hold time window. It should be appreciated that the clock transition may be referenced from the center or midway point of the clock transition or from another agreed upon reference point of the clock transition.

Signal integrity issues occur in an electronic system when the data input to a storage device has its logic value changed momentarily by the noise (e.g. cross-coupling) of a nearby aggressor wire transitioning. If this happens during the time period of the clock transition minus the setup time, to the clock transition plus the hold time, the new state of the storage device may be incorrect. If the cross-coupling occurs well outside of the time period, the momentary change in value (or noise) on the data input is not a problem.

The momentary change in the data is not an issue when the noise occurs outside of the time period from the clock transition minus the setup time, to the clock transition plus the hold time, because the circuit driving the input data wire will bring the input data wire back to its proper value. The time it takes to bring the input data wire back to its proper value is known as the recovery time. As a result, a noise event occurring prior to the clock transition minus the setup time can still cause a bad value in the storage device after the clock transition minus the setup time. During this period of time the storage device can latch or store incorrect data. The time period or window where the storage device may store this incorrect data is known as a victim vulnerability window, where the victim vulnerability window is defined as a time period from the clock transition minus the setup time, minus the recovery time, to the clock transition plus the hold time.

The time (e.g. window) during which aggressor wires can transition are determined by analysis tools such as simulation or static timing analysis tools. These windows are referred to as aggressor timing windows. The aggressor timing windows are determined by timing analysis of the design. The victim vulnerability window is determined by storage device design.

When an aggressor timing window overlaps a victim vulnerability window, the aggressor timing window is defined as a critical timing window. The overlap refers to a period of time during which both windows occur. The critical timing windows are those timing windows that include transitions that fall within the vulnerability window and as such may cause a storage device to latch or store the wrong or invalid data.

In the method and apparatus of the present invention an error is defined as when a storage component (e.g. internal node or output port) produces an incorrect or invalid state (e.g. 0 or 1). The storage devices are modeled in a simulator. Therefore, the parameters of the storage devices are known. As a result, during simulation, the state of a device at any point can be calculated (e.g. an expected state). The expected state is compared against the actual state produced during the simulation to determine whether there is an incorrect or invalid state.

Wires (traces) carrying signals to storage devices or output ports may be defined as aggressor wires (traces) or victim wires (traces). Aggressor and victim wires (traces) may carry electrical signals to a single component or may carry electrical signals to different components. Aggressor wires (traces) couple onto the victim wires (traces).

In the present invention, each trace or wire connecting components can be both an aggressor and/or a victim trace. In addition, wires (traces) couple during a transition of state, therefore, the aggressor wires (traces) are analyzed for a potential transition of state. In the method and apparatus of the present invention, the victim wires (traces) under analysis, carry signals (e.g. current) to a storage device or to an output port and are within proximity of aggressor wires that are transitioning.

In the method and apparatus of the present invention, an analysis is made of timing windows for each wire that carries signals to a storage device or output port; and each wire in physical proximity, to the wire that carries signals to the storage device or output port. Each wire in the electronic system is analyzed as a potential aggressor or victim relative to another wire or component.

The timing window for all possible aggressor wires are reduced to a subset of timing windows that become the focus of the analysis. The subset of timing windows are known as critical timing windows. As mentioned above, the critical timing windows are defined as aggressor timing windows, which overlap with victim vulnerability windows.

A worse case scenario is then defined for simulation purposes. The transitions on aggressor wires are adjusted within their respective critical timing windows. This is accomplished by adjusting the stimulus to the device driving the aggressor wire, so that the transitions on the aggressor wire, is adjusted toward the victim vulnerability window; while still remaining within the critical timing window.

Adjusting the aggressor transitions within the critical timing windows toward the victim vulnerability window, creates a worse case scenario for the purposes of simulation. The worse case scenario magnifies the cross-coupling problem during simulation. As a result, successful redesign may be accomplished, with a significant error tolerance.

An extracted circuit is then used to simulate the worse case scenario. The extracted circuit is implemented using simulation software and the extracted circuit is used for testing the subset of wires (traces) that have a critical timing window. The cross-coupling problems are simulated by using the extracted circuit to test and monitor a storage component.

In the method and apparatus of the present invention, analysis is made of each storage device in the electronic system. The analysis is performed using physical measurement, software or other conventional methods. A storage device typically receives its timing information from a clock. For the purposes of discussion, a steady state clock signal may be represented with a level horizontal line. A transition is shown when the line moves from one level to a second level. The transition may either be upward or downward. A transition is either known as a leading edge transition or a transition is known as a trailing edge transition. A device that is responsive to a clock may either change state based on a leading edge transition or on a trailing edge of the transition.

As mentioned earlier each wire carrying signals to a storage component and every wire within physical proximity to the wire carrying signals to a storage component may be an aggressor or a victim. Aggressor wires (traces) couple to victim wires (traces) during transitions. The transitions for an aggressor wire occur within the timing window for the aggressor wire. Therefore, a timing window is assessed for each wire in the electronic system to facilitate the determination of whether the wire is an aggressor wire or a victim wire.

A subset of the timing windows are considered critical timing windows. Therefore each timing window in the electronic system is assessed to determine whether it is a critical timing window. An analysis is performed, to determine whether a timing window overlaps with a victim vulnerability window. If the timing window does overlap with the victim vulnerability window, the timing window is considered a critical timing window. The critical timing windows, which are a subset of the initial timing windows, become the focus of the analysis.

At this point in the analysis the victim vulnerability windows and the critical timing windows have been identified. For the purposes of simulation a worse case scenario is developed. The transition occurring within the critical timing window is adjusted toward the victim vulnerability window to create the worse case scenario.

The critical timing window is associated with a wire carrying a transition signal. This wire is an aggressor wire. As mentioned above, the transition is adjusted forward in time or backward in time toward the victim vulnerability window. This is accomplished by adjusting the input stimulus of a device driving the signals on the aggressor wire.

As a result of the adjustment, the signal transition of the aggressor wire is moved toward the victim vulnerability window. As mentioned earlier, forcing the transition closer to the victim vulnerability window creates a worse case scenario for the purpose of simulation.

After shifting the transitions in the critical timing windows toward the victim vulnerability window, a circuit is developed which simulates the performance conditions resulting from these adjustments. For the purposes of discussion, the circuit is known as the extracted circuit. The extracted circuit is a circuit used to simulate the cross-coupling problems identified by the earlier steps in the analysis. The extracted circuit takes resistance and capacitance to ground into consideration. In addition, cross-coupling between wires (traces) is simulated in the extracted circuit, by a coupling (e.g. parasitic) capacitor between victim wires and aggressor wires.

The circuits that are the focus of the extraction process are a subset of the total circuits in the electronic system. As a result, using the method and apparatus of the present invention, a subset of the overall electronic system is simulated. This results in a much simpler, less time-consuming simulation. In addition, the focus of the simulation is isolated to the key components, traces and circuits that are likely to have signal integrity problems such as cross-coupling.

Once the extracted circuit has been developed a simulation is performed on the extracted circuit. By designing the capacitive and resistive elements into the extracted circuit the simulation accounts for the resistive and capacitive effects in the electronic system. In performing the simulation, trouble areas can be identified and addressed. Ultimately, as a result of the simulation, it is possible to redesign these problem areas.

The simulation may be performed with conventional software packages. Libraries including predefined circuits and routines may be used to develop the extracted circuit and adjust the input parameters of various components. In addition, combinations of simulation software and physical circuits may be used to simulate the extracted circuit.

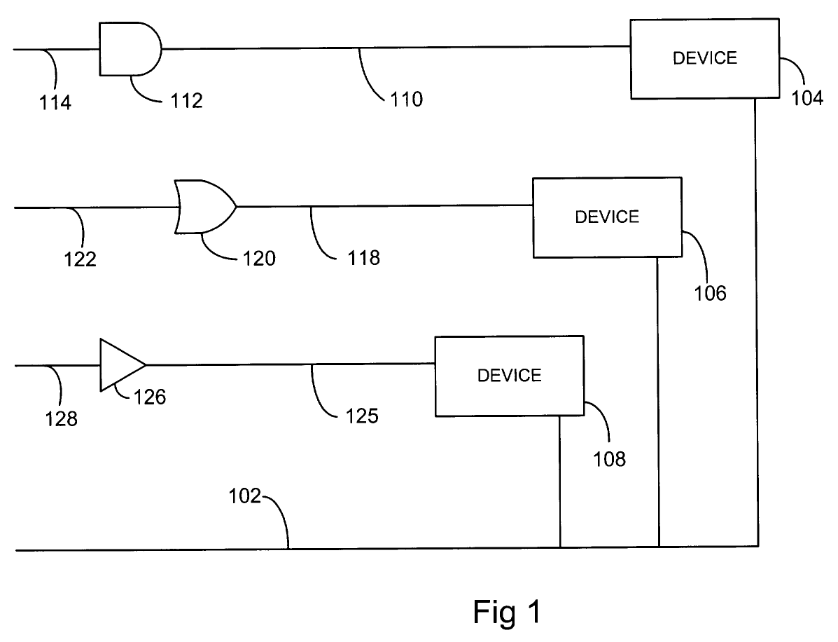

A digital electronic system is displayed in FIG. 1. A clock shown as 102 may be a system clock or a device clock dependent on a system clock. The clock 102 provides timing information to devices 104, 106, and 108. The devices 104, 106 and 108 may be storage devices such as a flip-flop, latch array, or devices 104, 106 and 108 may be other types of digital devices.

In one embodiment of the present invention, devices 104, 106 and 108 are storage devices. A wire 110 carries a transition to storage device 104. A logic device such as an AND gate 112 or some other type of logic device drives the wire 110 which carries the transition to device 104. Wire 114 carries a transition through device 112 and onto wire 110, which is input to device 104.

A wire 118 carries a transition to storage device 106. A logic device 120 such as an OR gate drives the wire 118 which carries the transition to storage device 106. A wire 122 carries an input signal to the OR gate 120. During the time of interest wire 122 along with 118 may be in a steady-state condition.

A wire 125 carries a transition to device 108. A logic device such as a buffer 126 or some other type of logic device drives the wire 125, which carries the transition signal to device 108. Wire 128 carries a transition through device 126, onto wire 125 and into device 108.

In one embodiment of the present invention, device 106 is a storage device. A set up and hold time is associated with the storage device 106. The set up time is defined as the minimum time that the input to the storage device 106 must be stable before receiving a timing signal to transition to another state. The hold time is defined as the minimum time that an input to the storage device 106 must stay valid after receiving a clock transition. As stated earlier, the set up and hold

time is related to the clock signal 102, which is an input into storage device 106.

Each of the wires (traces) 110, 118 and 125 has a timing window associated with the wire. The timing window is bounded by the earliest time that a transition in the signal will reach the wire and a latest time that a transition in the signal will reach the wire. As a result, the difference between the earliest time that a transition in the signal will reach the wires (traces) 110, 118 and 125 and the latest time that a transition in the signal will reach the wires (traces), is considered the timing window for the wires (traces) 110, 118 and 125.

Wires (traces) 110, 118 and 125 carry signals to devices 104, 106 and 108 respectively. For the purpose of demonstrating the method of the present invention, wires (traces) 110 and 125 may be considered aggressor wires (traces) and wire 118 may be considered a victim wire. The aggressor wires (traces) 110 and 125 couple onto the victim wire 118 and could potentially cause a change of state in storage device 106. As a result, storage device 106 may produce invalid or incorrect data.

In the method and apparatus of the present invention, each of the input wires (traces) 110, 118 and 125 carrying signals to devices 104, 106 and 108 respectively, may be considered an aggressor or a victim. Therefore in the initial analysis of the system a review is made of each wire in the electronic system.

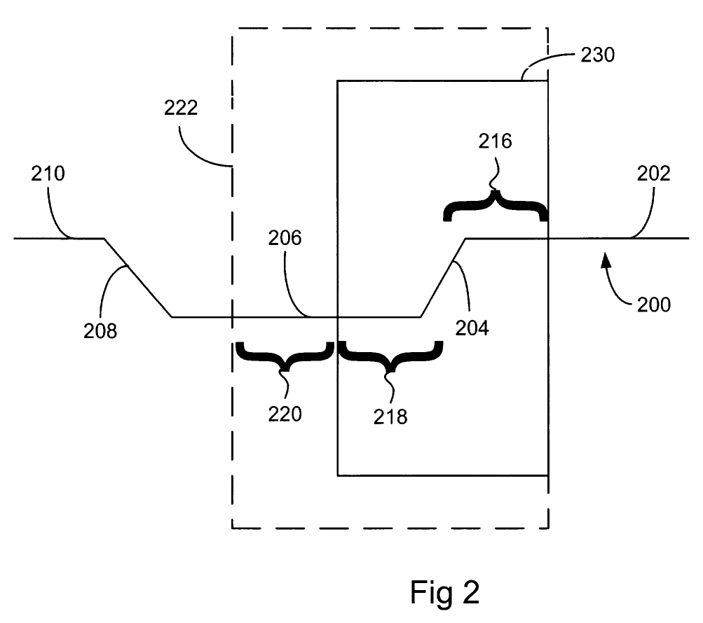

In FIG. 2 a clock signal is shown as 200. The clock signal includes a graphical depiction of a logical 1 shown 210. A falling transition is shown as 208 and a graphical depiction of a logical 0 is shown as 206. A rising transition is shown as 204 and a graphical depiction of a logical 1 is shown as 202. In FIG. 2 a clock transition 204 would be considered the transition edge. A time period that the data input must be stable before the clock transition 204, is known as the setup time. Item 218 represents a graphical depiction of the setup time. A time period that the data input to a storage device must remain stable after the clock transition edge 204, is known as the hold time. Item 216 represents the hold time. A setup and hold time window is then displayed as 230. The setup and hold time window is bounded by the clock transition 204 minus the setup time 218 and the clock transition 204 plus the hold time 216.

A victim vulnerability window 222 is also depicted in FIG. 2. The time it takes for a driving device to bring a data input back to its proper value is known as the recovery time. A recovery time is shown as 220. A data input to a storage device must stay stable throughout the time period defined by the victim vulnerability window. Therefore a victim vulnerability window 222 is shown as a time period from a clock transition 204 minus the setup time 218, minus the recovery time 220, to the clock transition 204 plus the hold time 216.

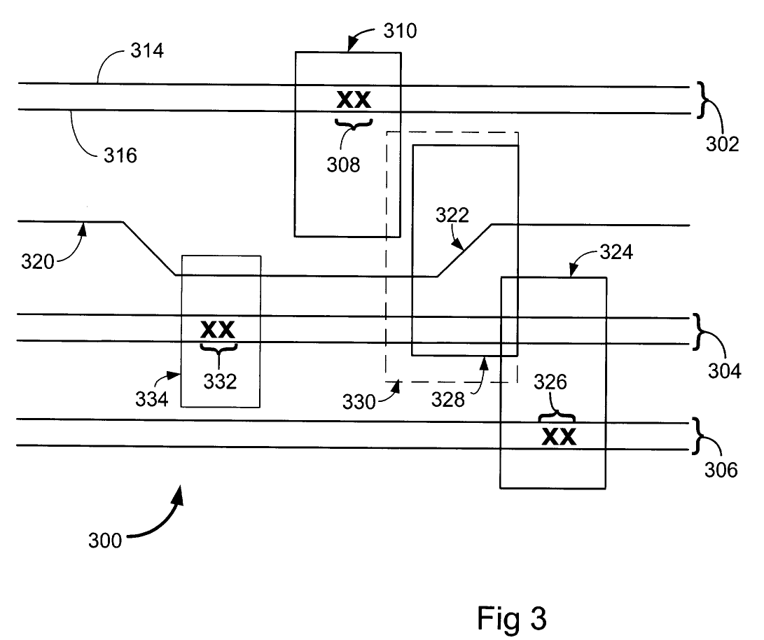

In FIG. 3 a timing diagram 300 is shown. The timing diagram 300 of FIG. 3 corresponds to the circuit shown in FIG. 1. In FIG. 3 item 302 corresponds to aggressor wire 110 of FIG. 1. Item 304 corresponds to victim wire 118 of FIG. 1 and item 306 corresponds to aggressor wire 125 of FIG. 1.

In FIG. 3 item 302, which corresponds to a first aggressor wire, may include a high (e.g. logical 1) signal denoted by 314, a low (e.g. logical 0) signal denoted by 316 and a transition denoted by 308. The transition 308 may be a rising transition or a falling transition. In addition, device 104 of FIG. 1 may respond to the transition 308 on the leading edge or on the trailing edge.

The transition 308 occurs within a timing window 310. The window 310 is bounded by the earliest time that the transition 308 may occur and the latest time a transition 308 may occur.

A timing diagram for a victim wire 304 is shown. The timing diagram of the victim wire 304 corresponds to wire 118 of FIG. 1. The timing diagram for victim wire 304 includes a transition 332. In addition a timing window for the transition 332 is shown as 334.

A clock signal is shown as 320. The clock signal 320 is associated with the clock input (e.g. 102 of FIG. 1) to a storage device (e.g. storage device 106 of FIG. 1). The clock signal 320 includes a transition edge 322. The setup and hold time window 328 is shown within the victim vulnerability window 330.

In FIG. 3 item 306, which corresponds to a second aggressor wire (e.g. wire 125 of FIG. 1), includes a transition denoted by 326. The transition 326 identifies the time at which a second aggressor wire transitions from a first logical

value to a second logical value. The transition 326 may be a rising transition or a falling transition. In addition, device 108 of FIG. 1 may respond to the transition 326 on the leading edge or on the trailing edge.

The transition 326 occurs within a timing window 324. The timing window 324 is bounded by the earliest time that transition 326 may occur and the latest time that transition 326 may occur.

In one method of the present invention timing windows associated with each wire in the electronic system are analyzed. A subset of the timing windows are denoted as critical timing windows. Critical timing windows are timing windows, which overlap with a victim vulnerability window.

The method of determining the critical timing windows will be discussed with respect to the timing diagram of FIG. 3. As shown in FIG. 3 timing windows 310 and timing window 324 both overlap with victim vulnerability window 330. As a result, timing windows 310 and 324 are considered critical timing windows, because the transitions 310 and 326 respectively, occur close enough to clock transition 322 to cause cross-coupling between the aggressor wires associated with 302 and 306 and the victim wire associated with 306.

In the method of the present invention, timing windows that overlap with the victim vulnerability window are considered critical timing windows because, these timing windows relate to wires (traces) that have transitions close to the setup and hold time of a storage device. From the discussion above, it was mentioned that cross coupling between wires (traces) occur during signal transitions. Therefore, if wires (traces) surrounding a wire, which carries input signals to a storage device, are transitioning during the victim vulnerability window, there is a potential for the signals to couple onto the wire (e.g. victim) carrying a data input signals to the storage device.

Once the critical timing windows have been identified for the circuit configuration (e.g. FIG. 1), adjustments are made to analyze the circuit under the worse case scenario. Using the example of FIG. 3, the worse case scenario is developed by moving the transitions 308 and 326 associated with a first aggressor wire and a second aggressor wire as close to the victim vulnerability window 330 as possible. The transitions 308 and 326 are adjusted toward the victim vulnerability window 330, by adjusting the input stimulus of components driving the wires (traces) on which these transitions occur. Since timing diagram 302 and 306 correspond to wires (traces) 110 and 125 of FIG. 1; this would mean adjusting the parameters of components 112 and 126 of FIG. 1.

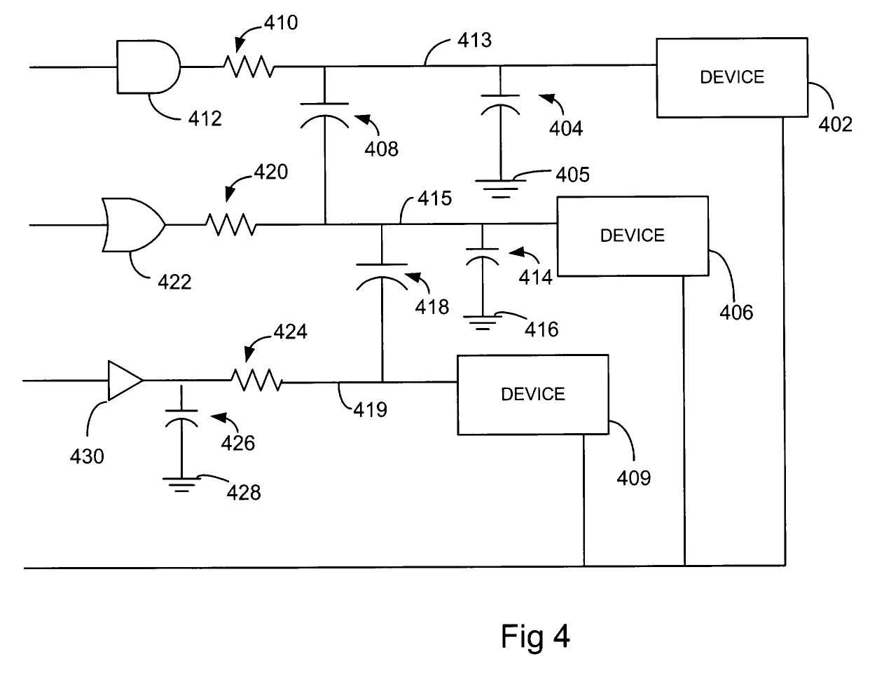

FIG. 4 is an extracted circuit of the circuit of FIG. 1, which accounts for cross coupling and resistive load of the components shown in FIG. 1. Devices 402, 406 and 409, correspond to devices 104, 106 and 108 in FIG. 1. Logic components 412, 422, and 430 of FIG. 3 correspond to logic components 112, 120 and 126 of FIG. 1. In addition, input wire 110 of FIG. 1 is simulated with aggressor wire 413. The aggressor wire 413 includes a capacitance going to ground a shown by 404 and 405 of FIG. 4. In addition, the resistance of input wire 110 of FIG. 1 is shown as resistor 410 of FIG. 4. Lastly, coupling capacitance between aggressor wire 110 and victim wire 118 of FIG. 1 is depicted by capacitor 408 of FIG. 4.

Storage device 406 corresponds to storage device 106 of FIG. 1. In addition, input wire 118 of FIG. 1 is simulated with victim wire 415. The victim wire 415 includes a capacitance going to ground a shown by 414 and 416 of FIG. 4. In addition, the resistance of input wire 118 of FIG. 1 is shown as resistor 420 of FIG. 4.

Device 409 corresponds to device 108 of FIG. 1. In addition, input wire 125 of FIG. 1 is simulated with aggressor wire 419. The aggressor wire 419 includes a capacitance going to ground a shown by 426 and 428. In addition, the inherent resistance of input wire 125 of FIG. 1 is shown as resistor 424 of FIG. 3. Lastly, coupling capacitance between aggressor wire 125 and victim wire 118 of FIG. 1 is depicted by capacitor 418 of FIG. 3. The extracted circuit is used for the purposes of simulating the problem areas in the electronic systems. System redesigns may then be accomplished.

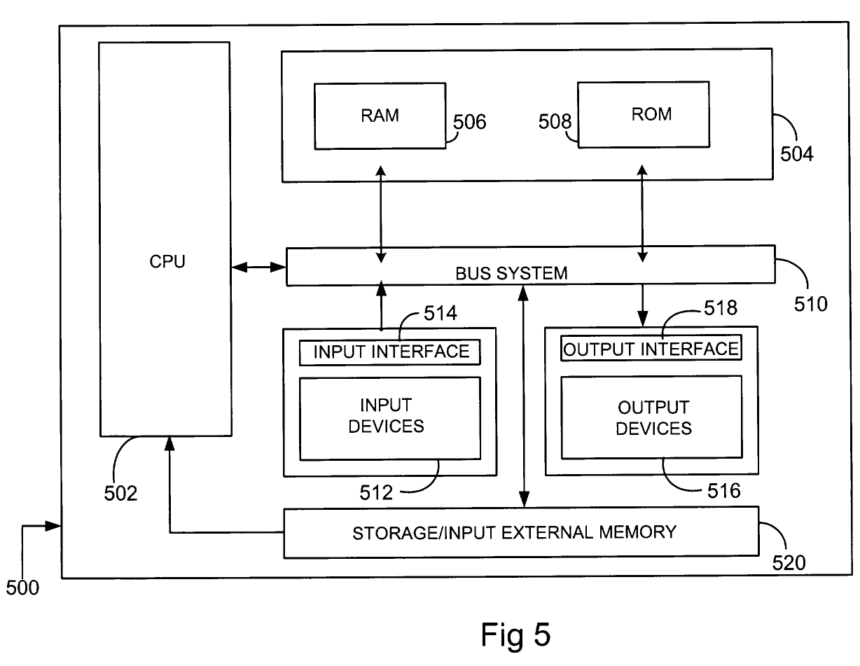

The method and apparatus of the present invention may be implemented using a multifunction computer. The method of the present invention may be accomplished by performing simulations in hardware, software or in a combination of the two. FIG. 5 is a block diagram of a computer 500 implementing the software methodology of the present invention. In FIG. 5 a central processing unit (CPU) 502 functions as the brains of the computer 500. Internal memory 504 is shown. The internal memory includes short term memory 506 and long term memory 508. The short term memory 506 may be Random access memory (RAM) or a memory cache used for staging information. The long term memory 508 may be a read only memory or an alternative form of memory used for storing information. A bus system 510 is used by the CPU 502 to control the access and retrieval of information from short term memory 506 and long term memory 508.

Input devices such as joy stick, keyboards or a mouse are shown as 512. The input devices 512 interface with the system through an input interface 514. Output devices such as a monitor, speakers, etc are shown as 516. The output devices interface with the computer 500 through an output interface 518. External memory such as a hard drive is shown as 520. A library of circuits and routines used in the present invention are stored in the external memory 520, in the ROM 508 or in a combination of the two.

The method and apparatus of the present invention may be implemented in software such as simulation software. The electronic system is implemented using devices from a device library of the simulator. The library includes the devices and the parameters for the devices. The devices are combined in the simulator to form circuits. The circuits of interest will be extracted based on the library cells used in the design. This will give an accurate circuit for use in the circuit simulator. Once the circuit of interest has been extracted in accordance with the method of the present invention, a simulation is performed using the set of parameters defining the devices and circuits.

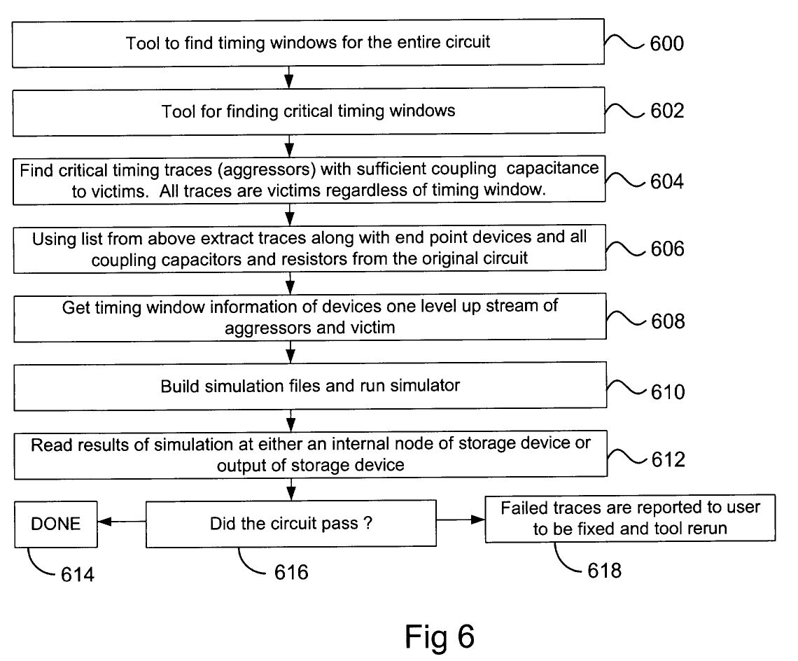

FIG. 6 is a flow diagram depicting a method used in the present invention. A software tool is used to find timing windows for the circuit or electronic system under analysis as shown by 600. A subset of timing windows are identified using a software tool for finding the critical timing windows as shown at 602. A tool is then used to determine the traces (e.g. aggressors) with sufficient coupling capacitance to a victim to cause a storage device receiving input from the victim, to produce invalid data as shown by 604.

In the present embodiment, the traces are presented as a list. Using the list of traces, an extraction is made of the traces along with the endpoint devices and the coupling capacitors and resistors from the original circuit as shown at 606. The timing window information of the devices one level up-stream of the aggressor and victim traces is retrieved as shown by 608. Simulation files may then be developed and run as shown by 610. The results of the simulation are read at a storage device as shown at 612. A comparison with an expected value is reviewed to determine if the device passed as shown at 616. If the storage device indicates the correct state the simulation is completed as shown by 614. If the test of the external node or the internal node produces an invalid state, then the failed traces are reported to an end-user as shown by 618.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A method of determining signal integrity comprising the steps of:
defining a victim vulnerability window;
identifying a plurality of critical timing windows in response to defining the victim vulnerability window; and
determining signal integrity in response to moving the plurality of critical timing windows relative to the victim vulnerability window.

2. A method of determining signal integrity as set forth in claim 1, wherein the victim vulnerability window includes a time period defined by a clock transition minus a setup time minus a recovery time to the clock transition plus the hold time.

3. A method of determining signal integrity as set forth in claim 1, wherein the critical timing windows are timing windows, which overlap with the victim vulnerability window.

4. A method of determining signal integrity as set forth in claim 1, wherein the step of determining signal integrity is the step of determining cross-coupling.

5. A method of determining signal integrity as set forth in claim 1, wherein the step of determining signal integrity further comprises the step of defining a worse case scenario by moving the plurality of critical timing windows relative to the victim vulnerability window.

6. A method of determining signal integrity as set forth in claim 1, further comprising the steps of,
generating an abstracted circuit in response to the critical timing windows; and
simulating the abstracted circuit.

7. A method as set forth in claim 1, wherein a computer readable medium stores computer instructions the computer instructions causing a computer to perform the method of claim 1 when accessed by a computer.

8. A system comprising:
means for defining a victim vulnerability window;
means for identifying a plurality of critical timing windows in response to defining the victim vulnerability window; and
means for determining signal integrity in response to moving the plurality of critical timing windows relative to the victim vulnerability window

9. A method of performing simulation comprising the steps of:
determining timing windows in a circuit including traces, each trace connecting driving devices to storage devices;
defining a victim vulnerability window;
determining critical timing windows in response to the timing windows and in response to the victim vulnerability window;
determining aggressor traces in response to the critical timing windows;
determining victim traces receiving enough coupling from the aggressor traces;
identifying a subset of the storage devices in response to the victim traces;
generating an extracted circuit in response to the aggressor traces, in response to the victim traces and in response to the subset of storage devices;
generating a worse case scenario in response to the extracted circuit; and
simulating the worse case scenario.

10. A method of determining a vulnerability window for a storage device including an input, the method comprising the steps of:
defining a clock transition;
defining a first boundary of the vulnerability window as the clock transition, minus a setup time for the storage device, minus a recovery time for the input to the storage device; and
defining a second boundary of the vulnerability window as the clock transition plus the hold time for the storage device.

11. A method as set forth in claim 10, wherein a computer readable medium stores computer instructions the computer instructions causing a computer to perform the method of claim 10 when accessed by a computer.

12. An apparatus comprising:
mean for defining a clock transition;
means for defining a first boundary of the vulnerability window as the clock transition, minus a setup time for the storage device, minus a recovery time for the input to the storage device; and
means for defining a second boundary of the vulnerability window as the clock transition plus the hold time for the storage device.
